(19) United States
(12) Patent Application Publication
(10) Pub. No.: US 2014/0023350 A1
(43) Pub. Date: Jan. 23, 2014

(54) VIDEO RECORDING APPARATUS

(71) Applicants: Jui-Hsiang YANG, NEW TAIPEI CITY (TW); Hung-Shen SU, NEW TAIPEI CITY (TW); Jiun-Kuei JUNG, NEW TAIPEI CITY (TW)

(72) Inventors: Jui-Hsiang YANG, NEW TAIPEI CITY (TW); Hung-Shen SU, NEW TAIPEI CITY (TW); Jiun-Kuei JUNG, NEW TAIPEI CITY (TW)

(73) Assignee: AVERMEDIA TECHNOLOGIES, INC., NEW TAIPEI CITY (TW)

(21) Appl. No.: 13/602,330

(22) Filed: Sep. 4, 2012

(30) Foreign Application Priority Data
Jul. 17, 2012 (TW) 101125637

(51) Int. Cl. H04N 5/92

(52) U.S. Cl. 386/327; 386/326

(57) ABSTRACT

A video recording apparatus includes a graphics card, a hardware recorder card and a storage device. The graphics card is used to generate a video signal. The hardware recorder card and the graphics card are both placed in a computer. The hardware recorder card includes a video loop-through unit and a bridge. The video loop-through unit captures the video signal from the graphics card and distributes the video signal to the bridge and a display. The storage device is electrically connected to the bridge, and is used to store the video signal via the bridge.

### CROSS-REFERENCE TO RELATED APPLICATIONS

This application claims priority to Taiwan Application Serial Number 101125637, filed Jul. 17, 2012, which is herein incorporated by reference.

### BACKGROUND

1. Technical Field

Embodiments of the present disclosure relate to a video recording apparatus. More particularly, embodiments of the present disclosure relate to a video recording apparatus for recording displayed images of a computer.

2. Description of Related Art

With the considerable development of multimedia technology in computers, more and more people use computers to watch videos or play games, instead of doing these activities on TV. However, typical video recording apparatuses are generally designed to record images displayed on TV, but cannot record videos or games displayed on a computer screen Therefore, video recording apparatuses for recording images displayed on a computer screen have been developed.

With such an apparatus, images displayed on a computer screen can be recorded by image capturing software such as FRAPS® or XSplit®, and these images can be compressed by the software. However, a large amount of computer memory is required with this kind of image capturing software. When such image capturing software is executed at the same time as playing a video or executing a computer game program, not only is a great amount of the resource of the computer processor utilized, but also, the playing of the video or the execution of the computer game program may not occur smoothly.

In addition to the aforementioned image capturing software, the images displayed on a computer screen can also be recorded by outputting the images to an external device such as another computer or a video recorder. However, the use of such an additional computer or video recorder may increase cost, and may also complicate the recording procedure.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In accordance with one embodiment of the present disclosure, a video recording apparatus for recording displayed images of a computer includes a graphics card, a hardware recorder card and a storage device. The graphics card is used to generate a video signal. The hardware recorder card and the graphics card are both placed in the computer. The hardware recorder card includes a video loop-through unit and a bridge. The video loop-through unit captures the video signal from the graphics card and distributes the video signal to the bridge and a display. The storage device is electrically connected to the bridge for storing the video signal via the bridge.

In accordance with another embodiment of the present disclosure, a video recording apparatus for recording displayed images of a computer includes a graphics card, a hardware recorder card and a network interface. The graphics card is used to generate a video signal. The hardware recorder card and the graphics card are both placed in the computer. The hardware recorder card includes a video loop-through unit and a bridge. The video loop-through unit captures the video signal from the graphics card and distributes the video signal to the bridge and a display. The network interface is electrically connected to the bridge for transmitting the video signal to a to network.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a video recording apparatus in accordance with one embodiment of the present disclosure;

FIG. 2 is a block diagram of a video recording apparatus in accordance with another embodiment of the present disclosure;

FIG. 3 is a block diagram of a video recording apparatus in accordance with another embodiment of the present disclosure; and

FIG. 4 is a block diagram of a video recording apparatus in accordance with another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

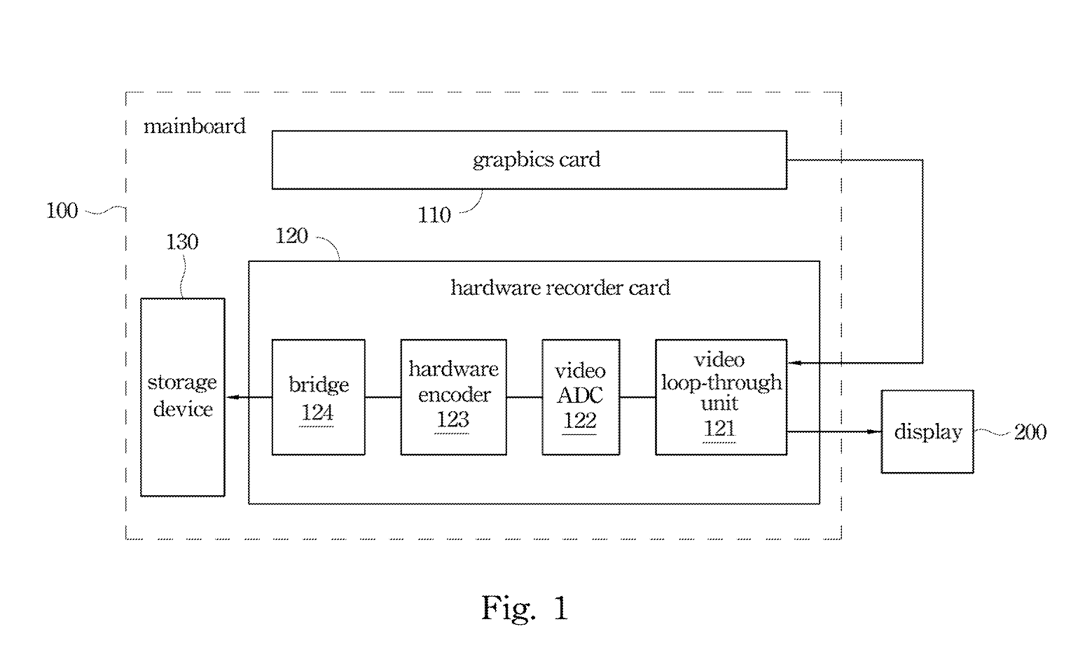

FIG. 1 is a block diagram of a video recording apparatus in accordance with one embodiment of the present disclosure. As shown in this figure, the video recording apparatus may include a graphics card 110, a hardware recorder card 120 and a storage device 130. The graphics card 110 is used to generate a video signal. The hardware recorder card 120 and the graphics card 110 are both placed in the same computer. The hardware recorder card 120 includes a video loop-through unit 121 and a bridge 124. The video loop-through unit 121 captures the video signal from the graphics card 110 and distributes the video signal to the bridge 124 and a display 200. The storage device 130 is electrically connected to the bridge 124 of the hardware recorder card 120 for storing the video signal via the bridge 124.

In this embodiment, the graphics card 110 and the hardware recorder card 120 are both placed or installed in the same computer. For example, the graphics card 110 and the hardware recorder card 120 can both be installed on the main board 100 of a single computer, and therefore, the hardware recorder card 120 can be used to record the images displayed on the display 200 without the use of an additional computer or video recorder. Further, the hardware recorder card 120 is a hardware device per se, and therefore includes a chip and/or a circuit for calculation. As a result of this configuration, the hardware recorder card 120 doesn't waste the resource of the computer processor in the manner that the typical image capturing software does.

In this embodiment, the hardware recorder card 120 may further include a video ADC 122 (Analog to Digital Converter) for converting the video signal in analog form into a digital video signal. Specifically, the graphics card 110 can transmit the video signal in analog form to the video loop-through unit 121 via an interface such as VGA (Video Graphic Array), DVI (Digital. Visual Interface, DVI), HDMI (High-Definition Multimedia Interface, HDMI) or Display Port. The video loop-through unit 121 can distribute the video signal in analog form to the display 200 and the bridge 124. In this embodiment, the video ADC 122 is placed downstream of the video loop-through unit 121, so that the video signal in analog form can be converted into a digital video signal (namely, a video signal in digital form), after which the storage device 130 stores this digital signal.

In this embodiment, the video loop-through unit 121 can be electrically connected to the video ADC 122 and the display 200 separately, and it can transmit the video signal from the graphics card 110 to each of the video ADC 122 and the display 200. The digital video signal generated by the video ADC 122 can be transmitted to the storage device 130 via the bridge 124. Therefore, when the display 200 shows images, the storage device 130 can store the data of the images (such as the video signal) simultaneously or at a later time.

The video ADC 122 can be implemented by using various analog-to-digital circuits, such as a Counting ADC, a Successive-Approximation ADC, a Parallel-Comparator ADC, or a Dual-Slope ADC (also called a radiometer ADC). The manufacturer can choose different types of circuits based on different demands, and these ADCs disclosed above are given simply by way of example, and should not be used to limit the present disclosure.

In this embodiment, the hardware recorder card 120 may further include a hardware encoder 123 (also called an HW encoder) for encoding the digital video signal. Specifically, the hardware encoder 123 is placed downstream of the video ADC 122, and can receive the digital video signal generated by the video ADC 122 to encode the same.

The hardware encoder 123 can be implemented by using a CPU (central processor unit), a microprocessor, a DSP (digital signal processor), an ASIC chip for audio/video encoding or any combination thereof and in cooperation with a circuit. The hardware encoder 123 is a hardware device for encoding signals. Because the typical video recording method is generally performed by software, the processor of the computer must be used to encode signals, and therefore, the resource of the CPU on the main board 100 must be utilized. In contrast, because the hardware encoder 123 employed in the embodiment is a hardware device per se it can use the hardware resource therefore (such as a CPU, a microprocessor, a DSP, or ASIC chip) to encode the signal without using the CPU on the main board 100, such that the quality of any video that is being played or game program that is being executed at the same time can be improved. In some embodiments, the hardware encoder 123 can encode the signal in different form such as Divx, Xcid, H.263, H.264, and so on, but the signal forms into which the hardware encoder 123 can encode is not limited to these example signal forms.

In this embodiment, the bridge 124 can be an interface between the hardware encoder 120 and the storage device 130, and can be used to transmit the digital video signal encoded by the hardware encoder 123 to the storage device 130. In some embodiments, the bridge 124 conforms to a protocol such as PCI, PCIe, USB, PCMCIA, or express card, but is not limited to conform to these protocols. It should be noted that the storage device 130 also includes a corresponding interface to connect to the bridge 124. In this yet embodiment, the storage device 130 may include, but is not limited to include, a hard disc, a USB flash drive, other storage devices, or the like.

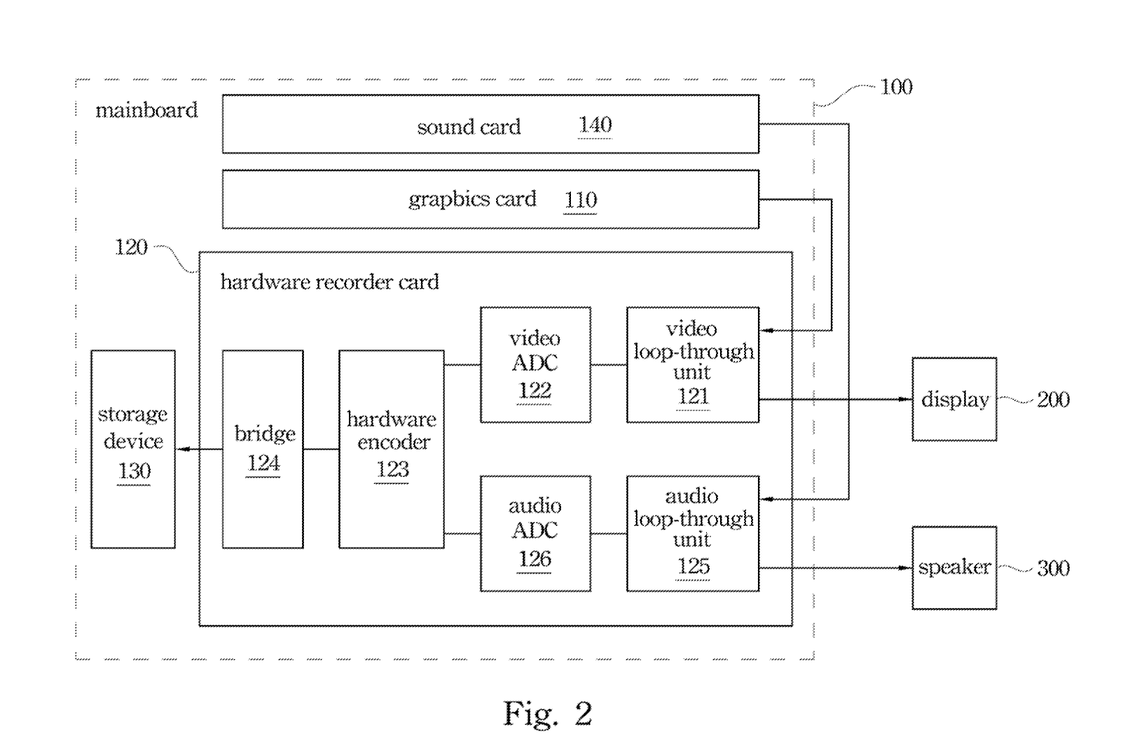

FIG. 2 is a block diagram of the video recording apparatus in accordance with another embodiment of the present disclosure. The main difference between this embodiment and the embodiment shown in FIG. 1 is that this embodiment further includes a sound card 140, and the hardware recorder card 120 includes an audio loop-through unit 125. The sound card 140 is used to generate an audio signal. The audio loop-through unit 125 is used to capture the audio signal from the sound card 140, and distributes the audio signal to the bridge 124 and a speaker 300. The storage device 130 can store the audio signal via the bridge 124. Therefore, the video recording apparatus of the embodiment not only can record the image displayed on the display 200, but also can record the sound played by the speaker 300.

In this embodiment, the video recording apparatus may further include an audio ADC 126 for converting the audio signal in analog form into a digital audio signal. Specifically, the sound card 140 can transmit the audio signal in analog form to the audio loop-through unit 125 via the interface conforming to a protocol such as L/R audio or S/PDIF. The audio loop-through unit 125 can transmit the audio signal in analog form to the speaker 300 and the bridge 124 separately. In this embodiment, the audio ADC 126 is placed downstream of the audio loop-through unit 125, so as to convert the audio signal in analog form into the digital audio signal, after which the storage device 130 stores this digital signal.

In this embodiment, the audio loop-through unit 125 can be connected to the audio ADC 126 and the speaker 300 separately, and it can transmit the audio signal from the sound card 140 to each of the audio ADC 126 and the speaker 300. The digital audio signal generated by the audio ADC 126 can be transmitted to the storage device 130 via the bridge 124. Therefore, when the speaker 300 plays sounds, the storage device 130 can store the data of the sounds (such as the audio signal) simultaneously or at a later time.

The audio ADC 126 can be implemented by using various analog-to-digital circuits, such as a Counting ADC, a Successive-Approximation ADC, a Parallel-Comparator ADC, or a Dual-Slope ADC (also called a radiometer ADC). The manufacturer can choose different types of circuits based on different demands, and these ADCs disclosed above are given simply by way of example, and should not be used to limit the present disclosure.

Further, the hardware encoder 123 can also encode the digital audio signal generated by the audio ADC 126. In other words, the hardware encoder 123 is also placed downstream of the audio ADC 126, so as to receive the digital audio signal and encode the same, thereby facilitating storage of the digital audio signal by the storage device 130.

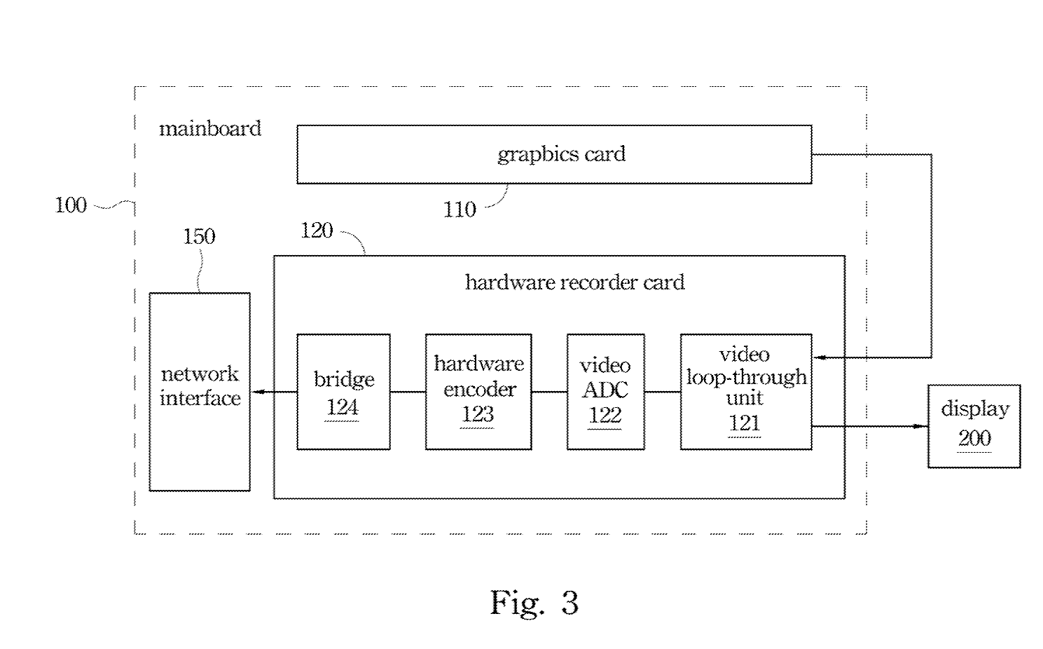

FIG. 3 is a block diagram of the video recording apparatus in accordance with another embodiment of the present disclosure. This embodiment is similar to the embodiment shown in FIG. 1. However, in this embodiment, a network interface 150 replaces the storage device 130 of FIG. 1. Specifically, the network interface 150 is electrically connected to the bridge 124 of the hardware recorder card 120, and is used to transmit the video signal from the bridge 124 to the network. Therefore, the video signal can be transmitted to another computer or a server via the network interface 150, so that the images displayed on the display 200 can be recorded remotely.

In some embodiments, the network interface 150 may further include an encryption unit (not shown) to encrypt the video signal, thereby promoting security when the video signal is transmitted via the network.

In this embodiment, the graphics card 110, the display 200, the video loop-through unit 121, the video ADC 122, the hardware encoder 123 and the bridge 124 are the same as the corresponding elements in the embodiment shown in FIG. 1. Hence, the operations of and connections among these elements can be ascertained by consulting the description above given with reference to FIG. 1.

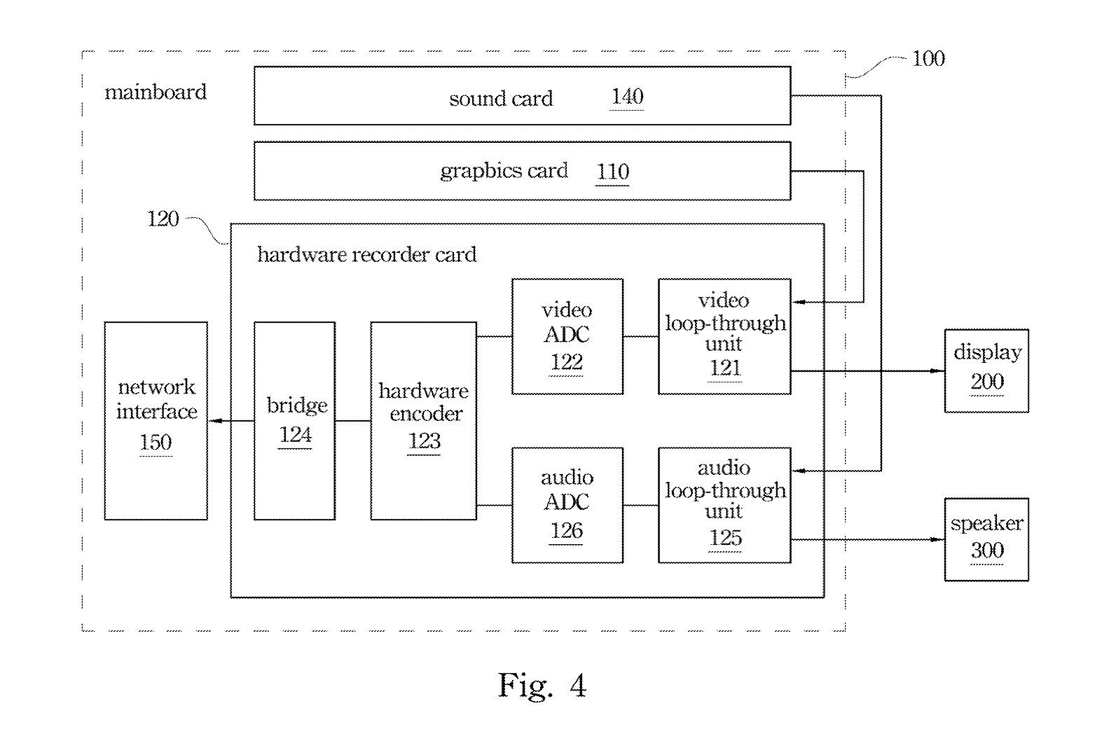

FIG. 4 is a block diagram of the video recording apparatus in accordance with another embodiment of the present disclosure. This embodiment is similar to the embodiment shown in FIG. 2. However, in this embodiment, a network interface 150 replaces the storage device 130 of FIG. 2. Specifically, the network interface 150 is electrically connected to the bridge 124 of the hardware recorder card 120, and is used to transmit the video and audio signals from the bridge 124 to the network. Therefore, the video and audio signals can be transmitted to another computer or a server via the network interface 150, so that the images displayed on the display 200 and the sounds played by the speaker 300 can be recorded remotely.

In some embodiments, the network interface 150 may further include an encryption unit (not shown) to encrypt the video and audio signals, thereby promoting security when the video and audio signals are transmitted via the network.

In this embodiment, the graphics card 110, the sound card 140, the display 200, the video loop-through unit 121 the video ADC 122, the hardware encoder 123, the bridge 124, the audio loop-through unit 125 and the audio ADC 126 are the same as the corresponding elements in the embodiment shown in FIG. 2. Hence, the operations of and connections among these elements can be ascertained by consulting the description above given with reference to FIG. 2.

In one or more embodiments of the present disclosure, the display 200 may include, but is not limited to include, an LCD, a PDP (Plasma Display Panel), an OLED (Organic Light Emitting Diode), a CRT (Cathode Ray Tube), and so on.

In one or more embodiments of the present disclosure, the speaker 300 may include, but is not limited to include, an amplifier, a loudspeaker, an earphone, and so on.

In view of the aforementioned embodiments, the graphics card 110 and the video recorder card 120 can both be placed on the main board 100 of the same computer. Because the video recorder card 120 is a hardware device instead of software, the resource of the CPU on the main board 100 can be saved. Further, because the video recorder card 120 installed on the main board 100 can enable video recording without any additional computer or video recorder, the costs associated with an additional computer or video recorder can be avoided.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A video recording apparatus for recording displayed images of a computer, comprising:
a graphics card for generating a video signal;
a hardware recorder card, wherein the graphics card and the hardware recorder card are both placed in the computer, the hardware recorder card comprising a video loop-through unit and a bridge, the video loop-through unit capturing the video signal from the graphics card and distributing the video signal to the bridge and a display; and
a storage device electrically connected to the bridge for storing the video signal via the bridge.

2. The video recording apparatus of claim 1, wherein the hardware recorder card comprises:
a video ADC (Analog to Digital Converter) for converting the video signal in analog form into a digital video signal.

3. The video recording apparatus of claim 2, wherein the hardware recorder card comprises:
a hardware encoder for encoding the digital video signal.

4. The video recording apparatus of claim 1, wherein the video loop-through unit is electrically connected to the bridge and the display separately.

5. The video recording apparatus of claim 1, further comprising:
a sound card for generating an audio signal;
wherein the hardware recorder card comprises an audio loop-through unit for capturing the audio signal from the sound card and distributing the audio signal to the bridge and a speaker.

6. The video recording apparatus of claim 5, wherein the hardware recorder card comprises:
an audio ADC (Analog to Digital Converter) for converting the audio signal in analog form into a digital audio signal.

7. The video recording apparatus of claim 6, wherein the hardware recorder card comprises:
a hardware encoder for encoding the digital audio signal.

8. The video recording apparatus of claim 5, wherein the audio loop-through unit is electrically connected to the bridge and the speaker separately.

9. The video recording apparatus of claim 1, wherein the interface of the graphics card is VGA, DVI, HDMI or Display Port.

10. The video recording apparatus of claim 1, wherein the protocol of the bridge is PCI, PCIe, USB, PCMCIA, or express card.

11. A video recording apparatus for recording displayed images of a computer, comprising:
a graphics card for generating a video signal;
a hardware recorder card, wherein the graphics card and the hardware recorder card are both placed in the computer, the hardware recorder card comprising a video loop-through unit and a bridge, the video loop-through unit capturing the video signal from the graphics card and distributing the video signal to the bridge and a display; and
a network interface electrically connected to the bridge for transmitting the video signal to a network.

12. The video recording apparatus of claim 11, wherein the hardware recorder card comprises:
a video ADC (Analog to Digital Converter) for converting the video signal in analog form into a digital video signal.

13. The video recording apparatus of claim 11, wherein the hardware recorder card comprises:
a hardware encoder for encoding the digital video signal.

14. The video recording apparatus of claim 11, wherein the video loop-through unit is electrically connected to the bridge and the display separately.

15. The video recording apparatus of claim 11 further comprising:
a sound card for generating an audio signal;
wherein the hardware recorder card comprises an audio loop-through unit for capturing the audio signal from the sound card and distributing the audio signal to the bridge and a speaker.

16. The video recording apparatus of claim 15, wherein the hardware recorder card comprises:
an audio ADC (Analog to Digital Converter) converting the audio signal in analog form into a digital audio signal.

17. The video recording apparatus of claim 16, wherein the hardware recorder card comprise:
a hardware encoder for encoding the digital audio signal.

18. The video recording apparatus of claim 15, wherein the audio loop-through unit is electrically connected to the bridge and the speaker separately.

19. The video recording apparatus of claim 11, wherein the interface of the graphics card is VGA, DVI, HDMI or Display Port.

20. The video recording apparatus of claim 11, wherein the protocol of the bridge is PCI, PCIe, USB, PCMCIA, or express card.
